(19) United States
(12) Patent Application Publication
(10) Pub. No.: US 2018/0089501 A1
(43) Pub. Date: Mar. 29, 2018

(54) COMPUTER IMPLEMENTED METHOD OF DETECTING THE DISTANCE OF AN OBJECT FROM AN IMAGE SENSOR

(71) Applicant: UNIFAI HOLDINGS LIMITED, London (GB)

(72) Inventors: Vladislav TEREKHOV, London (GB); Ilya ROMANENKO, London (GB); Michael TUSCH, London (GB)

(21) Appl. No.: 15/828,922

(22) Filed: Dec. 1, 2017

Related U.S. Application Data
(63) Continuation of application No. PCT/GB2016/051600, filed on Jun. 1, 2016.

(30) Foreign Application Priority Data
Jun. 1, 2015 (GB) 1509387.5

(51) Int. Cl. G06K 9/00

(52) U.S. Cl. CPC G06K 9/00288; G06K 9/00228; G06K 9/00268

(57) ABSTRACT

There is provided a method for estimating a distance of an object detected by an image sensor. Multiple detections are performed automatically to detect features of an object and to estimate the object proportions, which are then used to relate to additional measurements such as the distance of the object from the image sensor. The method detects human and non-human objects. The method uses available anthropometry tables. The method takes into account the image sensor optical aberrations such as lens distortion. A related system and a related computer program product are also provided.

### CROSS-REFERENCE TO RELATED APPLICATIONS

This is a continuation of PCT Application No. PCT/GB2016/051600, filed on Jun. 1, 2016, which claims priority to GB Application No. GB 1509387.5, filed on Jun. 1, 2015, the entire contents of each of which being fully incorporated herein by reference.

### BACKGROUND OF THE INVENTION

### 1. Field of the Invention

The field of the invention relates to a method for image analysis, in particular for detecting the distance of an object from an image sensor, and to related systems, devices and computer program products.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Technical Background

Distance and/or age estimation are of growing importance for many computer vision applications ranging from robotic navigation, security, law enforcement, surveillance, access control or human computer interaction.

Examples of depth measurement sensors include Time of Flight (ToF) cameras and stereo sensors. ToF cameras measure distances based on the time of flight principle, which involves measurement of the time delay of a light pulse transmitted from a source, such as an IR laser, and then reflected by an object. Distance measurements from ToF sensors often do not provide accurate measurements when an object is located at a large distance due to the object being blurred with the background. Depth may also be measured by using a stereo or a multiple camera system, hence requiring more than one image sensor. Stereo sensors may provide good separation at large distance, however they require a calibration setup.

A large number of applications also rely on knowing a person's age and/or gender. A common method for estimating age is based on extracting and analysing facial features.

Other popular techniques are based on machine learning techniques such as Convolutional Neural Networks (CNN) and have shown good performance for estimating a person's age. However such techniques are computationally intensive as they involve training a system with a large number of examples based on the objects that the system needs to classify.

Although image processing techniques for age and gender estimation and classification are well known, being able to automatically estimate age or gender still remains a challenging problem.

Inaccuracy in estimation of a detected object attribute such as distance, age, or gender also often depend on optical aberrations such as lens distortion. Errors that are introduced by lens distortion will also vary depending on the type of lens that is used. Multiple sensors with different optical parameters may be used to capture a scene and distortion correction needs to be taken into account automatically and independently of the image sensor used.

### 3. Discussion of Related Art

U.S. Pat. No. 5,781,650 A discloses a process for automatically finding facial images of a human face in an electronically digitized image, and classifying the age of the person associated with the face into an age category.

U.S. Pat. No. 8,565,539 B2 discloses a system and a method for determining an estimated age of an individual of interest based on images in an image collection.

U.S. Pat. No. 7,319,779 B1 discloses a method and system for automatically extracting the multi-class age category information of a person from digital images. The system detects the face of the person(s) in an image, extracts features from the face(s), and then classifies into one of the multiple age categories.

U.S. Pat. No. 8,831,362 B1 discloses methods, systems, and apparatus, including computer programs encoded on a computer storage medium, for performing age estimation. One aspect includes submitting an image of a person to multiple classifiers, each with a scalar output suitable to determine a probability that the person is a member of a particular age group or not, or as a member of one age group or another.

U.S. Pat. No. 8,000,505 B2 discloses digital image processing method for determining the age of a human subject having redeye in a digital image.

U.S. Pat. No. 8,523,667 B2 discloses a method and a system for controlling access to an electronic media device. The technique automatically determines an age group of a user in a field of view of a camera based on metrics of a 3-D body model. The metrics can relate to, e.g., a relative size of a head of the body, a ratio of arm length to body height, a ratio of body height to head height, and/or a ratio of head width to shoulder width.

U.S. Pat. No. 7,912,246 B1 discloses a system and a method for performing age classification or age estimation based on the facial images of people, using multi-category decomposition architecture of classifiers.

### SUMMARY OF THE INVENTION

The invention is a computer implemented method of detecting the distance of an object from an image sensor, including the following steps: (i) detecting one or more objects and/or one or more object features using an image sensor and object and/or object feature detection algorithms; (ii) a processor automatically determining or calculating the relative size or ratio between different detected objects or object feature(s), and (iii) the processor calculating or inferring the distance of the object or object feature(s) from the sensor, based on the relative size or ratio that has been determined or calculated.

Optional features in an implementation of the invention include any one or more of the following:
the object is a human and the features include one or more of the following: face, head, head and shoulders, full figure, eyes, lips, ears and hands.
the detected features have one or more of the following metrics: size, angle, type, color information, temperature, position.
the metrics have two dimensional space (2D) parameters and/or three dimensional space (3D) parameters.
different detected features are used to estimate body proportions.
multiple objects are detected.
the sizes of features of a detected human are estimated from the size of features a detected non-human object, or vice versa.
the method is performed in real-time and without requiring calibration.
the method further comprises estimating the sizes of one or more features of a human by using anthropometry tables.
the method further comprises correlating estimated sizes of the one or more features of a human to available anthropometry tables in order to estimate an attribute of a detected human, such as sex or gender.
the method further comprises the step of estimating the size of missing features of the object from the sizes of the features that the system has been able to detect.
if the size of a hand is known, then estimating the sizes of the head and/or of the head and shoulders.
if the size of the head has been estimated, estimating the full figure size.
the method includes the step of predicting the size of the head and shoulders if the age of a person is known.
for each estimated value of the size of a feature, the method includes the step of calculating a confidence factor for the estimated measurement value.
the method includes the step of using the confidence factor to make a decision on whether the estimated value may be used for estimating the distance of the object.
the method provides estimated sizes of different features simultaneously and in real time.
the method comprises the step of re-calculating the estimated sizes of the different detected features or elements by taking into account image sensor optical parameters.
the method further comprises the step of calculating a lens distortion correction coefficient.
the lens distortion correction coefficient is used to calibrate the image sensor.
the method comprises the step of re-calculating the estimated sizes of the different features of the object by taking into account the lens distortion coefficient.
the method further comprises the step of automatically adding visual information next to a detected object or generating an audible message, describing the object attribute and the distance of the object from the image sensor.
the method is applied to a video stream recorded by a camera, in which the video stream includes frames, in which a detection algorithm is applied to each frame for detecting object(s) or features of objet(s), and in which the size of the object(s) and/or features of the object(s) are estimated and the distance of the objects from the camera are estimated on a frame-by-frame basis.
the method further comprises the step of the processor calculating or inferring the age of a person, based on the size or ratio of the different features of that person's body, that has been determined or calculated.
the method further comprises the step of using estimated sizes for a full figure and head, to estimate the age of the detected human by using available anthropometry tables.
the method is used in one of the following products:
   Camera;
   Smart Door Bell;
   Light Switch;
   Light bulb;
   Light emitting module;
   Any wearable devices;
   Any Smart Home devices.

Another aspect is a computer implemented method of detecting the distance of an object from an image sensor, including the following steps: (i) detecting one or more objects and/or one or more object features using an image sensor and object and/or object feature detection algorithms; (ii) a processor automatically determining or calculating the size of one or more detected objects or object feature(s), and (iii) the processor calculating or inferring the distance of the object or object feature(s) from the sensor, based on the size that has been determined or calculated.

Any one or more of the methods defined above includes a GPU which provides the computational resources to execute the algorithms.

Another aspect is computer vision system that implements any of the methods defined above.

The computer vision system implements algorithms for (i) object and/or feature detection and (ii) for determining or calculating the size of different detected objects or object features, and (iii) for calculating or inferring the distance of the object or object feature(s) from the sensor, based on the size that has been determined or calculated.

The computer vision system implements algorithms for (i) for determining or calculating the relative size or ratio between different detected objects or object features, and (ii) for calculating or inferring the distance of the object or object feature(s) from the sensor, based on the relative size or ratio that has been determined or calculated.

The computer vision system includes an embedded processor or other form of processor, the processor being a graphics processor adapted to provide the computational resources to execute the algorithms.

The computer vision system comprises an image sensor module implementing the methods as described above.

The image sensor module receives a video stream and analyses the video stream on a frame-by-frame basis.

The image sensor module reports the presence of an object along with additional information on the object including one or more of the estimated distance of the object from the sensor and/or other attributes of the object.

The image sensor module does not stream video to another device.

The computer vision system is implemented in an autofocus system, and in which focus of a lens is adjusted according to the estimated distance of a detected object.

The autofocus is performed automatically as soon as an object is detected, without requiring any calibration.

A further refinement of the autofocus is performed using conventional autofocus techniques.

The computer vision system forms part of a light switch, light bulb or light emitting module.

The computer vision system includes an image sensor module that receives a video stream and analyses the video on a frame-by-frame basis, and subsequently reports the presence of an object along with additional information on the object such as estimated distance of the object from the sensor and/or other attributes of the object.

The computer vision system forms part of a smart doorbell or security system sensor.

The computer vision system detects an object in real-time and automatically measures the distance of the object from the smart doorbell or security system sensor.

If the detected object is within a pre-defined area or distance, the system triggers further events.

The predefined area or distance is set by inputting that data directly.

The computer vision system forms part of a voice command control device.

The functionality of the voice command control device is enhanced by being programmed to perform various functions only if a detected object is located within a pre-defined area or distance.

The computer vision system is enhanced by being programmed to perform various functions only if a detected human is looking at the device or towards the device by detecting the pose of the body, or the orientation of the head.

The computer vision system is used in an automotive collision avoidance or autonomous driving system.

The computer vision system detects whether a detected object is human or non-human.

The computer vision system is used as an additional filter to assist the elimination of false positives.

Another aspect is an embedded processor adapted to operate with or form part of any one or more of the computer vision system defined above and to provide computational resources to execute the algorithms.

Another aspect is an optical sensor module that includes a computer-vision system that implements any one or more of the methods defined above.

Another aspect is a computer implemented method of detecting the age of a person using an image sensor, including the following steps: (i) detecting one or more features of the person using an image sensor and object feature detection algorithms; (ii) a processor automatically determining or calculating the size of several object features, and (iii) the processor calculating or inferring the age of the person from the sensor, based on the size or ratio of the different object features that has been determined or calculated.

The method includes the step of using estimated sizes for a full figure and head, to estimate the age of the detected human by using available anthropometry tables.

Another aspect is an image sensor system in which the sensor system includes or implements algorithms for (i) human body feature detection and (ii) for determining or calculating the size of different detected human body features, and (iii) for calculating or inferring the age of the human body, based on the relative size or ratio of the different human body features that has been determined or calculated.

### BRIEF DESCRIPTION OF THE FIGURES

Aspects of the invention will now be described, by way of example(s), with reference to the following Figures, which each show features of the invention:

FIG. 1 is a set of images illustrating human elements (an ‘element’ is any sort of detected feature), and elements created by either data analytics or ‘element parameters’ processing.

FIG. 2 is a set of images illustrating non-human elements, and elements created by either data analytics or ‘element parameters’ processing.

FIG. 3 is a diagram illustrating an example of anthropometry data sets.

FIG. 4 is a diagram schematically illustrating the optical flow (ray diagram) when imaging a human using a pin-hole camera model; the image is projected to a sensor area.

FIG. 5 is a diagram schematically illustrating the optical flow when imaging a human at two different distances from a sensor using a pin-hole camera model.

FIG. 6 is a set of images illustrating the ratio calculation used for lens distortion compensation.

FIG. 7 is a diagram schematically illustrating a simple algorithm flow for an embodiment of the invention.

FIG. 8 is a diagram schematically illustrating an algorithm flow for an embodiment of the invention.

FIG. 9 shows formulae referred to elsewhere in this document.

FIG. 10 shows formulae referred to elsewhere in this document.

### DETAILED DESCRIPTION

A method is provided for analysing a captured image from a scene from one or several image sensors. A detection algorithm is applied to the image in order to detect an object, and for estimating the size of the object and/or the size of particular features of the object and for estimating the distance of the object.

In addition, a method is provided for lens distortion compensation. The method includes the analysis of human and/or non-human elements of interest within captured image(s) from a scene from one or several image sensors.

The sensors may include one or more of the following sensors: sensors operating in the visible spectra, sensors operating in the infra red spectra, thermal sensors, ultra sonic sensors, sensors operating in the non-visible spectra and sensors for acceleration or movement detection.

A method is provided for estimating the gender and age of a detected human or for estimating the type of non-human object that has been detected (e.g. object classification).

The method may also be applied to a video stream recorded by a camera, in which the video stream includes frames, in which a detection algorithm is applied to each frame for detecting object(s) or features of objet(s), and in which the size of the object(s) and/or features of the object(s) are estimated and the distance of the objects from the camera are estimated on a frame-by-frame basis.

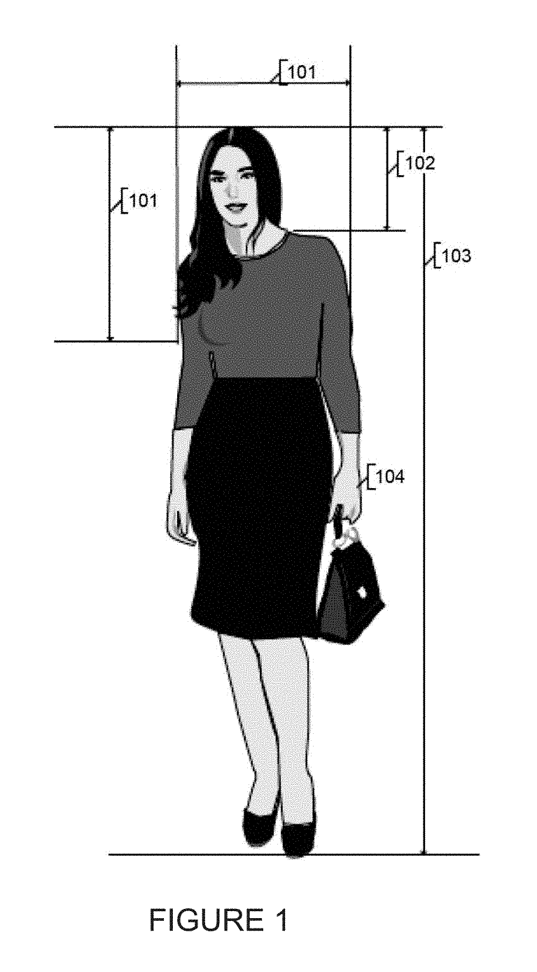

FIG. 1 shows an image used to assist in a detailed explanation of the key segments of a human body. The data analytics used to analyse the image is an extended block. One purpose of the data analytics is for image analysis and the detection of particular features. These detected features may include, for example, the face 102, the head and shoulders 101, the full FIG. 103, and the hands 104. The detected features may have the following metrics: size, angle, type, color information, temperature, position. These metrics may have two dimensional space (2D) parameters and/or three dimensional space (3D) parameters.

A detected feature may also refer to as an “element”. “Element parameters” are therefore 2D or 3D parameters that define or relate to the face 102, or head and shoulders 101 etc.

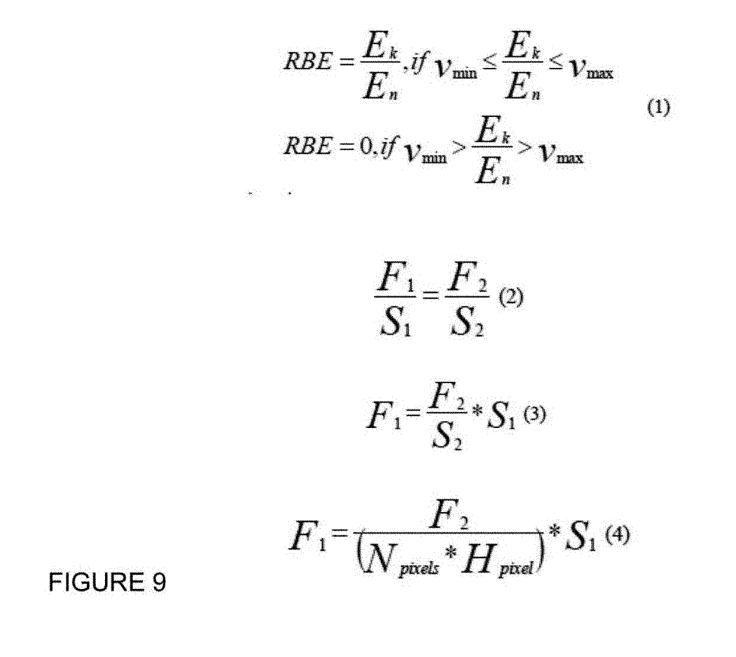

The human body has well determined relationships between single and multiple elements. The “Ratio Between Elements” (RBE) may be determined in accordance with Equation (1): see FIG. 9.

In Equation (1), Eₖ is the value associated with detected element k, Eₙ is the value associated with detected element n, Vₘᵢₙ is the minimum ratio value, and Vₘₐₓ is the maximum ratio value.

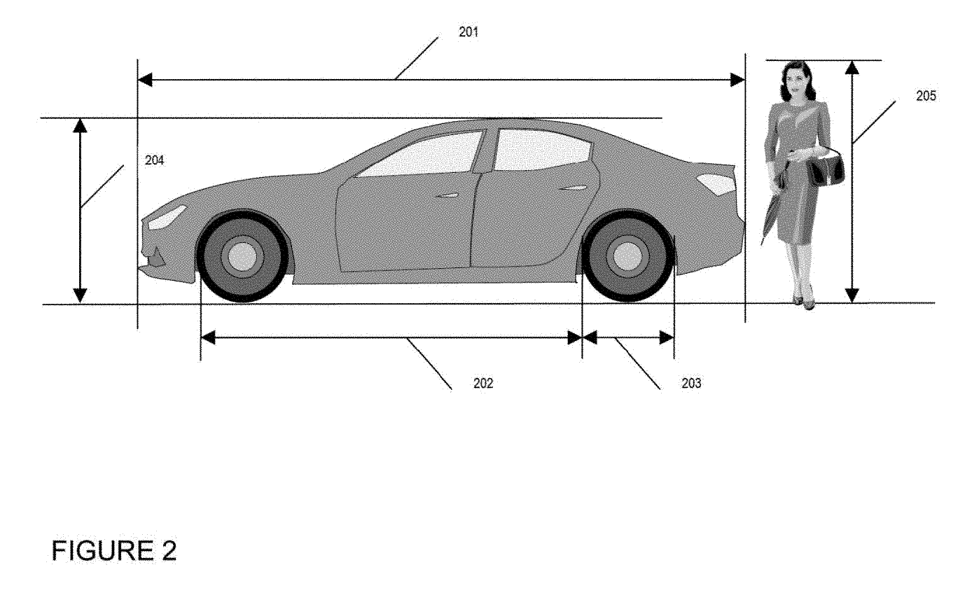

FIG. 2 shows an image including a non-human object and a human ‘object’. The data analytics may produce detections such as a wheel 203, an object length 201 and an object height 204. Particular objects may have well determined relationships between elements such as, the distance between front and back wheels 202. Additionally, some elements may have well known parameters, such as a wheel diameter 203 or a car width. The ratio between elements may also be determined in accordance with Equation (1): see FIG. 9. The body proportions of a human 205 may also be estimated by using calculated or known proportions of a non-human object, such as the car width.

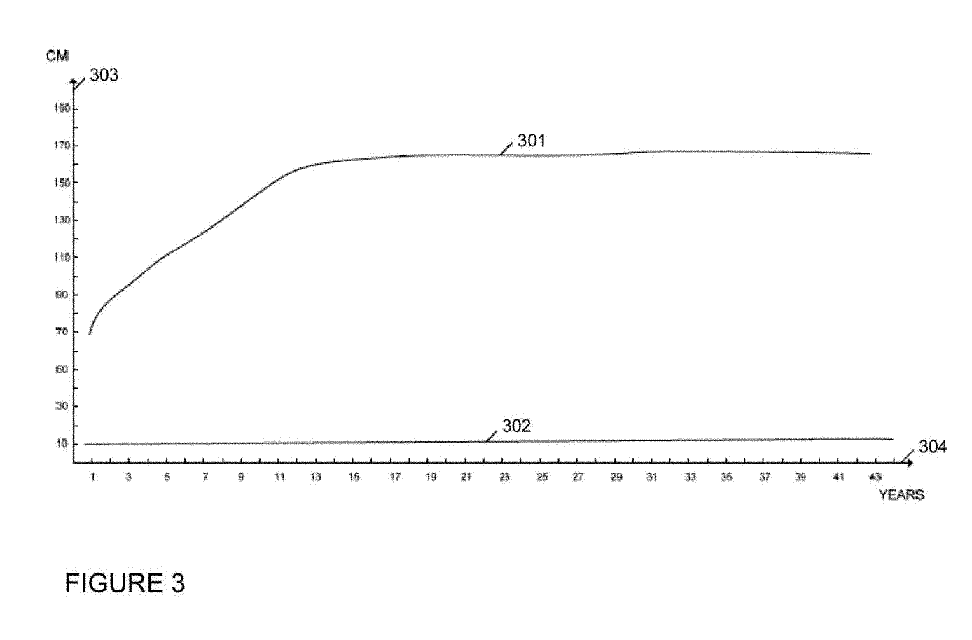

FIG. 3 shows an example of an anthropometry table. Anthropometry tables give measurements of different body parts for men and women, and for different age groups. An example of anthropometry data sets is presented in NASA Reference Publication 1024 ‘Anthropometric Source Book Volume II: A Handbook of Anthropometric Data’. Stature measurements 301 and head breadth measurements 302 are plotted in FIG. 3. The y-axis 303 is in centimeters and the x-axis 304 is in years. From the graph, it may be easy to recognize when the RBE between stature and head breadth have strong relationships. RBE values may therefore be estimated and the precision on the estimation may be strongly dependent on the specific standard deviation of a particular element, which is based on the physical properties of the element. Some elements of the human body may have a bigger standard deviation as compared to other elements.

Hence, stature values may be estimated. Similarly, in some cases it may also be possible to estimate age as well as gender. However, the probability of accurately estimating the gender of people under the age of thirteen years old may be quite low.

As an example, an image sensor may capture a scene including a human or part of a human. A detection algorithm, via the data analytics engine, may be applied to the captured image, which may result in multiple detections of features within the image. The head of the human may be detected first; the full figure of the human may then be detected, followed by the detection of the head and shoulders. The detections of the different features or parts of the human body may be performed automatically and simultaneously. The different detections are then used to estimate body proportions, which may then be used to relate more measurements based on the body subject to available anthropometry tables.

In addition, some parts of the human body may also be missing or may not be detected. Even though parts or features of the human body are missing from the captured image, their sizes may still be estimated from the sizes of the features that the system has been able to detect. As an example, it is possible to predict the size of the head and shoulders if the age of a person is known. As another example, if the size of the hand is known, it is possible to estimate the sizes of the head and of the head and shoulders. Furthermore, if the size of the head has been estimated, the full figure size may then be estimated, as an average person may be for example in the region of seven and a half heads tall. In some cases, it may also be possible to estimate gender. As an example, from estimated sizes for a full figure and head, it is often possible to estimate the age of the detected human by using available anthropometry tables.

One of the advantages of the method is that it provides estimated sizes of different features or parts of the body simultaneously and in real time.

Another advantage of the method is that no calibration is needed, and that size, distance, age and/or gender may be estimated automatically as long as an object has been detected.

Non-human objects may also be used to estimate the size and distance of other objects present and detected by an image sensor (see FIG. 2). As an example, a car may be detected by an image. Different parts of the car may be detected simultaneously, such as the wheels or the width. From the estimated car width, the distance of the detected car from an image sensor may also be estimated. Furthermore, the sizes of the different non-human features may also be used to estimate the size of another detected non-human object or of a detected human.

For each estimated body part measurement, the method may also calculate a confidence factor for the estimated measurement value. The confidence factor may then be applied to make a decision on whether the estimated body part value may be used for estimating the distance of the object. As an example, an image may detect a human, a human head, as well as the human head and shoulders. If a low confidence score is determined for the estimation of the head size, then this head size estimation may be discarded from further estimations. Thus, other body part measurement estimations will be made using the estimated head and shoulders size (with a high confidence score) rather than the estimated head size (with a low confidence score). If both estimated sizes have similar confidence scores, an average of the two may be used to estimate other body parts as well as the distance of the human from the image sensor.

The method provided also takes into account the image sensor optical parameters and further comprises the step of re-calculating the estimated sizes of the different elements by taking into account the image sensor optical parameters as explained via the following sections and figures.

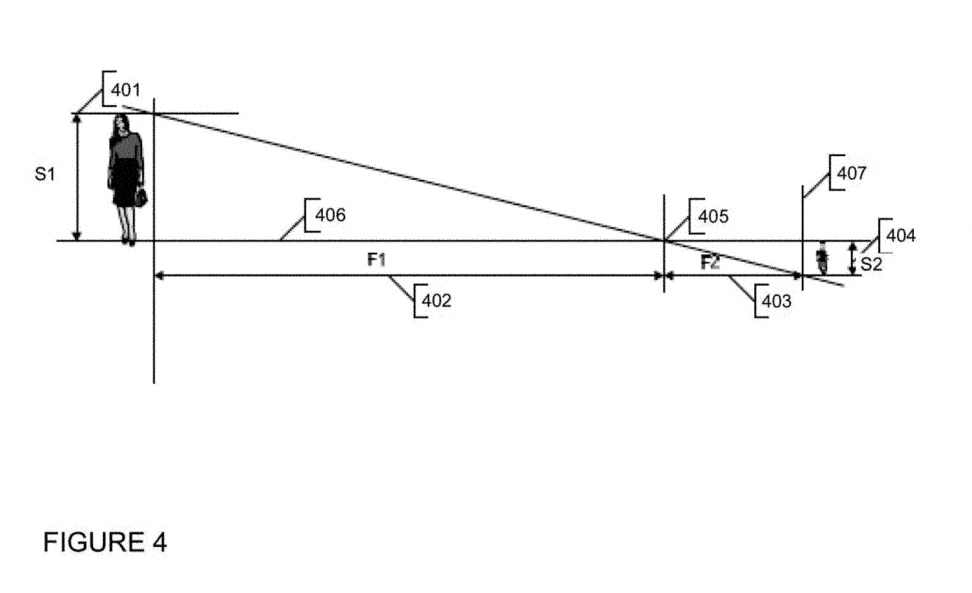

FIG. 4 shows a projection of a human body onto a sensor area 407 assuming a pinhole camera model. The relationships between a real human size Si and its projected size S2 can be described by Equation (2): see FIG. 9. In Equation (2), F1 is the distance between the human and the aperture 405, S1 is the human height, F2 is the distance between the human projected onto the sensor area and the aperture 405, S2 is the height of the human projected onto the sensor area.

The value of F1 may be determined in accordance with Equation (3): see FIG. 9.

By using the real size of the sensor and the element size in pixels, the value of F1 may be determined in accordance with Equation (4): see FIG. 9. In Equation (4), Nₚᵢₓₑₗₛ is the number of pixels associated with a detected element; Hₚᵢₓₑₗ is the size of a single pixel on the active area of the sensor.

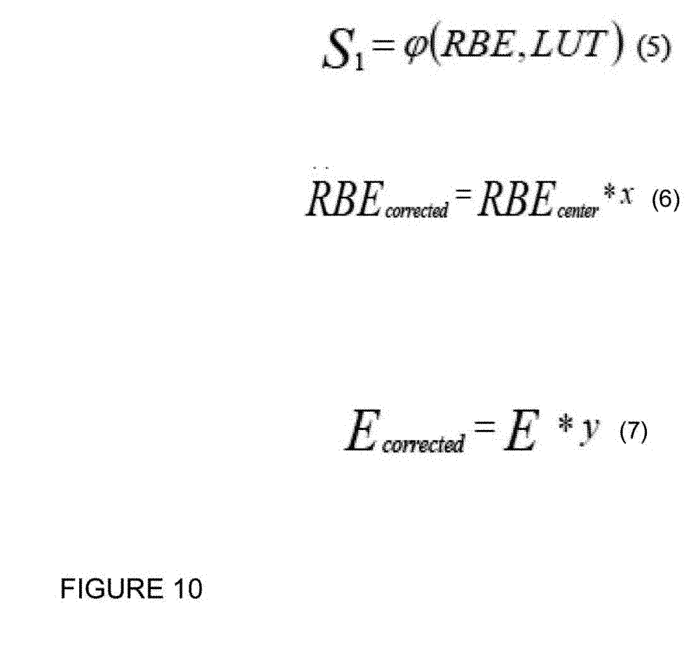

It is then possible to predict the value of S1 by either using a predetermined look-up-table or using an interpolation function combined with a predetermined look-up-table in accordance with Equation (5): see FIG. 10.

In Equation (5), LUT is a look-up-table containing the data set associated with detected elements.

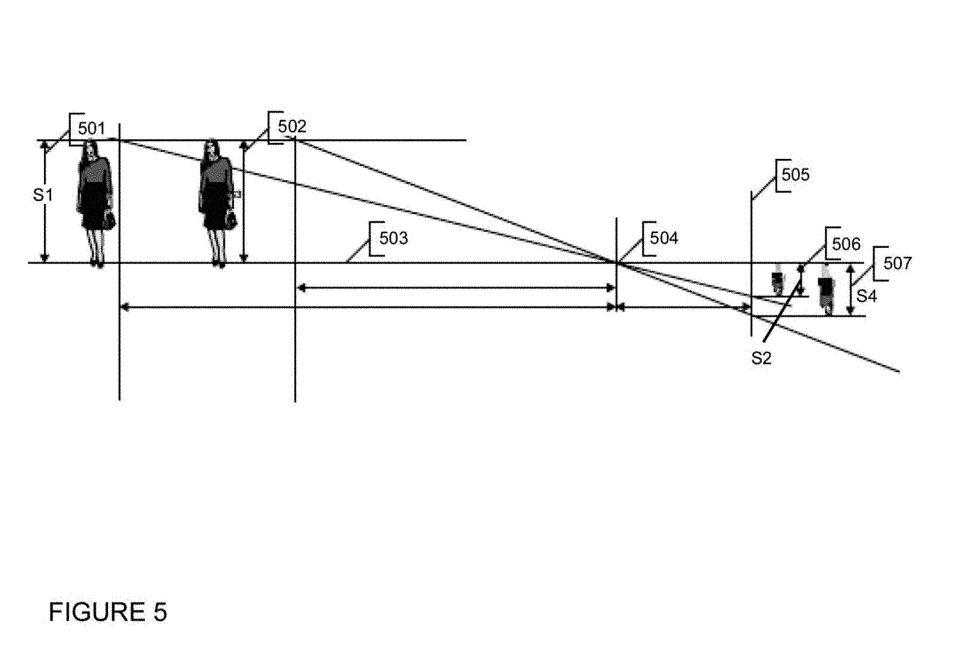

FIG. 5 shows the same human (501 and 502) positioned at two different distances from the sensor area 505. Assuming a pinhole camera model as discussed above, the RBE values for S1, S2, S3, S4 would be equal as the model would not include optical distortion caused by optical elements.

An accurate model for a system comprising optical elements must take into account optical distortion. A distortion is a deviation from rectilinear projection—a projection in which straight lines in a scene remain straight in an image—and is a form of optical aberration, which causes discrepancies when applying the pinhole camera model.

As a result, in a system comprising optical elements, the RBE values for S1 would not be equal to the RBE values for S2 and S4; and similarly, the RBE values for S3 would not be equal to the RBE values for S2 and S4. Distortions may increase with the distance from the optical axis 503. Hence the RBE value for S2 may have less error as in this example, S2 is closer to the optical axis.

The RBE value for minimum possible detection for the human positioned at a distance closer to the optical axis is referred to as RBE_{center}. A corrected RBE value RBE_{corrected} may be determined in accordance with Equation (6): see FIG. 10.

In Equation (6), x is the value of a correction coefficient. This lens distortion correction is referred to as RBE LDC.

A number of distortion correction methods exists that may be used as interpolation methods such as polynomial interpolation, 3 linear interpolation, barycentric interpolation or tetrahedral interpolation. The correction coefficient may also depend on the position of the object within the frame.

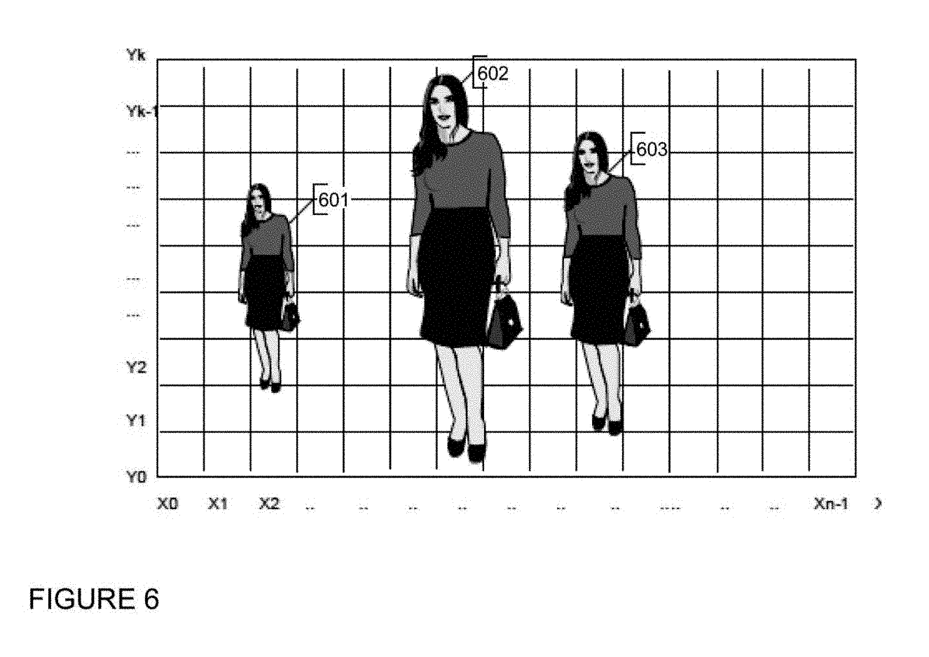

FIG. 6 shows the same human 601, 602, and 603 positioned at three different distances from a sensor area. In this example, the frame area is divided by vertical and horizontal lines forming a rectangular grid. The frame area may also be divided by other types of regular pattern, such as a triangular or a honeycomb grid arrangement. It may also be possible to use a radial grid, however this may not guarantee the same optical center position and sensor area center position. The grid may be used as a basis for lens distortion correction (LDC), referred to as ‘global lens distortion correction’. Global LDC may also be used to calculate a corrected size of a detected element. The correction value may be extracted from the nearest grid node, or may result from the interpolation between two or several grid nodes. For global LDC, the value in the grid node is a correction value for a detected element. Before using an element for RBE calculation, a new size of the element is calculated in accordance with Equation (7): see FIG. 10. In Equation (7), E is the size of a detected element and y is the correction value.

Calibrations may be performed statically or dynamically during a certain amount of time. Dynamic calibration may be done by using the same moving person in the field of view. The calibration procedure may calculate a correction coefficient. The calibration for global LDC may also be performed either statically by using special printed targets or dynamically by using the same moving person in the field of view.

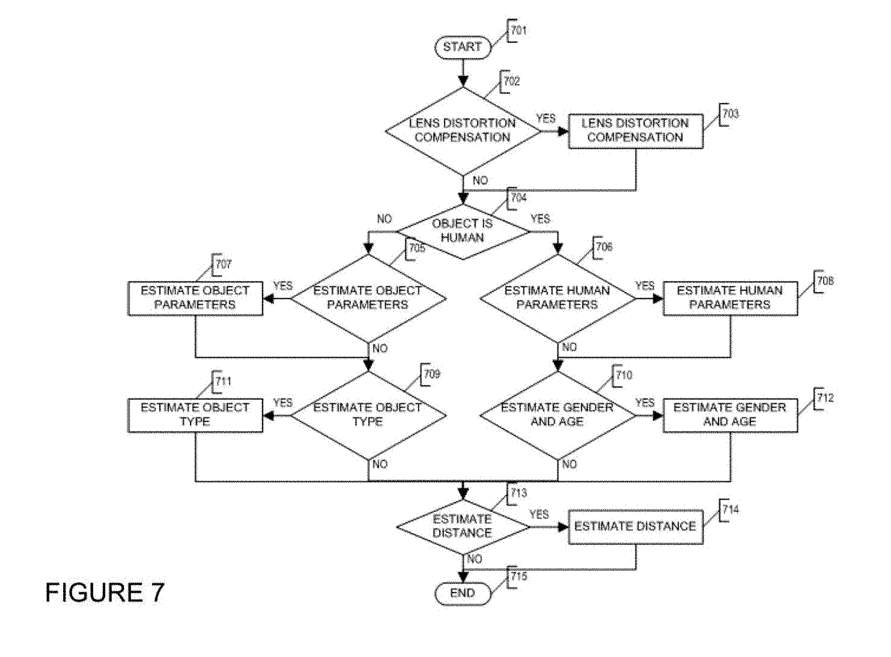

FIG. 7 shows a flow diagram with an example of the procedure for estimating the distance of an object. The block 703 first performs ratio or global LDC. The video analytics engine (VAE) is an extended block. The VAE detection may include the type of detection such as size, angle, speed, acceleration, center of weight, color signatures, pose, probability score, gender and etc. The human detection type may include for example: the face, head and shoulder, full figure, eyes, lips, hands, and etc. The detection may have 2D or 3D coordinates. The block 708 performs an estimation of the human parameters based on the VAE detections. The block 712 produces an estimation of human gender and age. The block 707 performs an estimation of the non-human parameters based on the VAE detections. The block 711 estimates the type of the object. The block 714 estimates the distance of the object.

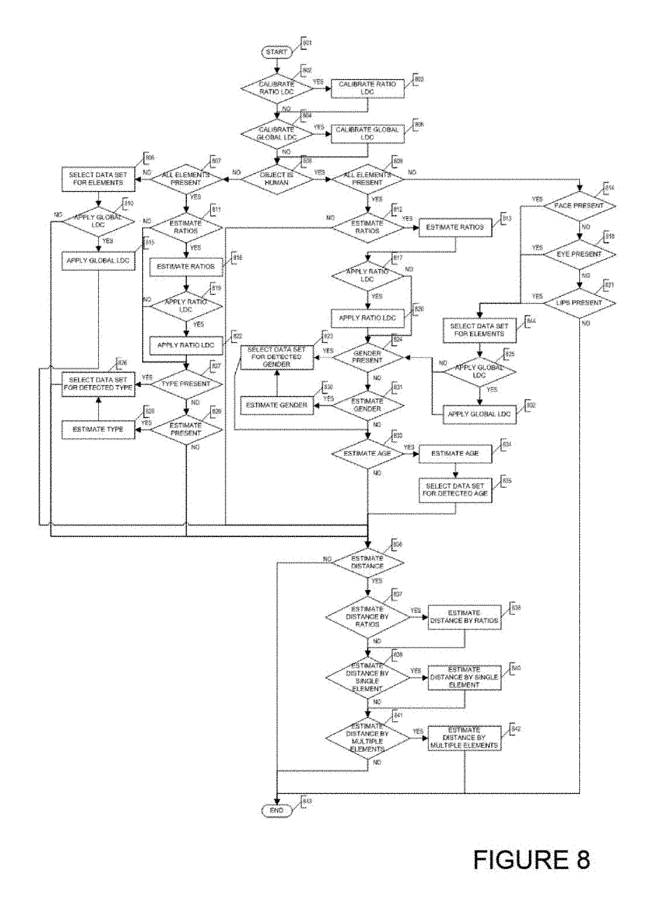

FIG. 8 shows a diagram with another more detailed example of the processing flow. The block 801 receives a set of detections from the VAE. The block 803 performs ratio LDC calibration. The calibration outputs a set of values arranged as 2D or 3D look-up-table. The block 805 performs global LDC calibration. The calibration may be performed statically or it may be performed dynamically during a certain amount of time. The calibration outputs a set of values arranged as a 2D or 3D look-up-table. The block 808 acquires information about the detection type. The non-human detections may be processed in the block 807 and human detections may be processed in the block 809. The block 809 acquires information about the number of human elements or features connected to a single person. At least two elements must be present to estimate RBE. The block 813 produces the RBE calculation for every person that is present in the detection set. The block 820 performs the correction of RBE previously calculated in the block 803 and 813. The block 823 selects the data set according to the appropriate gender. The data set may include for example the anthropometry data. The block 830 performs the gender estimation based on available detection parameters. The block 834 performs the age estimation. The estimated age is based on RBE and anthropometry data sets previously selected. The block 835 selects the data set with estimated anthropometry data. If at least one of the following: face, eye and lips, is detected in the block 814, 818, and 821, then the block 844 may be executed. The block 844 selects the data set based on anthropometry data. The block 832 applies global LDC to detection parameters. The block 838 performs the distance estimation based on RBE and detection parameters. The block 840 performs the distance estimation based on the selected anthropometry data set and detection parameters by using a single element. The block 842 performs the distance estimation based on the selected anthropometry data set and detection parameters by using multiple elements. The block 806 selects data set based on elements parameters. The data set may include predefined sizes, angles, distances and etc. The block 815 applies global LDC to detection parameters. The block 816 produces the RBE calculation for every non-human present in the detection set. The block 822 performs the correction of RBE previously calculated in the block 803 and 816. The block 826 selects the data set for each appropriate type. The data set may include the predefined RBE, sizes, angles, distances and etc. The block 828 performs the type estimation based on the available detection parameters.

The invention enables a large number of applications. Some use cases are listed as examples below.

Image sensor module: an image sensor may comprise a module implementing the methods as described above. The image sensor module may receive a video stream and analyse the video on a frame-by-frame basis, and may subsequently report the presence of an object along with additional information on the object such as estimated distance of the object from the sensor and/or other attributes of the object. The sensor module may not stream video to another device. The sensor module may be a SoC that includes a GPU; the GPU may itself be programmed to implement some or all of the methods described above. Having an embedded processor or SoC with sophisticated computer vision capabilities able to provide automatic distance detection would be very useful in many contexts. Where the automatic distance detection is implemented in firmware or hardware (or some combination of the two), then operation can be very fast and power efficient, key requirements for extending the capabilities of IoT computer vision systems.

Autofocus: the camera may adjust its focus according to the estimated distance of a detected object. The autofocus may be performed automatically as soon as an object is detected without requiring any calibration. Depending on the parameters of the image sensor used, a further refinement of the autofocus may or may not be done by the camera, e.g. using conventional autofocus techniques.

The sensor module may form part of a light switch, light bulb or light emitting module.

Light emitting module: a light-emitting module may comprise a plurality of LEDs soldered on a printed circuit board (PCB). There is often an area of unused PCB in between the LEDs, and this unused area may be used by an image sensor module. The image sensor may comprise a module implementing the methods as described above. The image sensor module may receive a video stream and analyse the video on a frame-by-frame basis, and may subsequently report the presence of an object along with additional information on the object such as estimated distance of the object from the sensor and/or other attributes of the object. The sensor module may not stream video to another device.

Smart doorbell or similar security systems: a smart doorbell system may for example be placed on or near an entrance door of a home. It may detect an object in real-time and automatically measure the distance of the object from the smart doorbell. In case the distance measured is greater than a pre-defined value, the system may ignore the object. If the object is within a pre-defined area, the system may trigger further events. Various security systems may have different sensors with different optical parameters. By measuring the distance to a detected object according to the methods defined above, this offers many advantages as compared to other methods of estimating distance by measuring pixel size. As the system provided here does not need calibration and takes into account optical aberrations, the predefined distance or area may be set for the different sensors by inputting directly the real distance from the sensors or the required area.

Connected voice command devices such as the Amazon Echo: the user experience of the device may be enhanced by integrating a sensor module which provides an estimated distance for a detected object. The device may be programmed to perform various functions only if the detected object is located within a pre-defined area. Additional detected features may also be included such as an indication on whether the detected human is looking at or towards the device (for example, by detecting the pose of the body, or the orientation of the head). The device may also only communicate if the detected human's age is above a certain value.

Automotive collision avoidance or autonomous driving system: such systems may be used to either provide an alert to a driver when there is an imminent collision or take action autonomously without any driver input. Such systems may be used for example to assist the driver in changing lanes or parking the vehicle. Current collision avoidance may use sensors that continuously sense the surrounding environment and detect nearby objects and may alert a driver of a possible collision. The alert may be in the form of an audible warning, for example, which may vary depending on the proximity of the detected object. A collision avoidance system integrating an optical sensor module implementing the methods described above may provide additional information on a nearby detected object, and may warn the driver if the object is human or non-human, and provide information on the distance of the object from the vehicle.

Additional filter to eliminate false positives: information on a detected object's distance or coordinates may be used as an additional filter to assist the elimination of false positives. As an example, if a camera surveys an outside scene and it detects that a human is located ten meters above the ground, the system may be used to infer that it is not possible and may eliminate the false positive.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A computer implemented method of detecting the absolute distance of an object from an image sensor, including the following steps: (i) detecting one or more objects and/or one or more object features using an image sensor and object and/or object feature detection algorithms; (ii) a processor automatically determining or calculating the relative size or ratio of sizes between different detected objects or object feature(s), and (iii) the processor calculating or inferring the absolute distance of the object or object feature(s) from the sensor, based on the relative size or ratio that has been determined or calculated.

2. The method of claim 1, in which the object is a human and the object features include one or more of the following: face, head, head and shoulders, full figure, eyes, lips, ears and hands.

3. The method of claim 1 in which the detected object features have one or more of the following metrics: size, angle, type, color information, temperature, position and in which the metrics have two dimensional space (2D) parameters and/or three dimensional space (3D) parameters.

4. The method of claim 1 in which different detected object features are used to estimate body proportions.

5. The method of claim 1 in which the sizes of features of a detected human are estimated from the size of features of a detected non-human object, or vice versa.

6. The method of claim 1 in which the method further comprises estimating the sizes of one or more features of a human by using anthropometry tables.

7. The method of claim 1, in which the method further comprises correlating estimated sizes of the one or more features of a human to available anthropometry tables in order to estimate an attribute of a detected human, such as sex or gender.

8. The method of claim 1, in which the method further comprises the step of estimating the size of missing features of the object from the sizes of the features that the system has been able to detect.

9. The method of claim 1 including the step of, if the size of a hand is known, then estimating the sizes of the head and/or of the head and shoulders.

10. The method of claim 1 including the step of, if the size of the head has been estimated, estimating the full figure size.

11. The method of claim 1 including the step of predicting the size of the head and shoulders if the age of a person is known.

12. The method of claim 1 in which, for each estimated value of the size of a feature, the method includes the step of calculating a confidence factor for the estimated measurement value and using the confidence factor to make a decision on whether the estimated value may be used for estimating the distance of the object.

13. The method of claim 1 in which the method comprises the step of recalculating the estimated sizes of the different detected features or elements by taking into account image sensor optical parameters.

14. The method of claim 1, in which the method further comprises the step of calculating a lens distortion coefficient and the lens distortion correction coefficient is used to calibrate the image sensor.

15. The method of claim 1, comprising the step of calculating a lens distortion coefficient and re-calculating the estimated sizes of the different features of the object by taking into account the lens distortion coefficient.

16. The method of claim 1, in which the method further comprises the step of automatically adding visual information next to a detected object or generating an audible message, describing the object attribute and the distance of the object from the image sensor.

17. The method of claim 1 when applied to a video stream recorded by a camera, in which the video stream includes frames, in which a detection algorithm is applied to each frame for detecting object(s) or features of objet(s), and in which the size of the object(s) and/or features of the object(s) are estimated and the distance of the objects from the camera are estimated on a frame-by-frame basis.

18. The method of claim 1, in which the method further comprises the step of the processor calculating or inferring the age of a person, based on the size or ratio of the different features of that person's body, that has been determined or calculated.

19. The method of previous claim 18, in which the method further comprises the step of using estimated sizes for a full figure and head, to estimate the age of the detected human by using available anthropometry tables.

20. The method of claim 1 when used in one of the following products:
Camera;
Smart Door Bell;
Light Switch;
Light bulb;
Light emitting module;
Any wearable devices;
Any Smart Home devices
An autonomous vehicle;
A robot.

21. A computer vision system that detects the absolute distance of an object from an image sensor and that implements algorithms for (i) detecting one or more objects and/or one or more object features; and (i) for determining or calculating the relative size or ratio of sizes between different detected objects or object features, and (iii) for calculating or inferring the absolute distance of the object or object feature(s) from the sensor, based on the relative size or ratio that has been determined or calculated.

22. The computer vision system of claim 21 in which the image sensor module reports the presence of an object along with additional information on the object including one or more of the estimated distance of the object from the sensor and/or other attributes of the object.

23. The computer vision system of claim 22 in which the image sensor module does not stream video to another device.

24. The computer vision system of claim 22 implemented in an autofocus system, and in which focus of a lens is adjusted according to the estimated distance of a detected object.

25. The computer vision system of claim 22 including an image sensor module that receives a video stream and analyses the video on a frame-by-frame basis, and subsequently reports the presence of an object along with additional information on the object such as estimated absolute distance of the object from the sensor and/or other attributes of the object.

26. The computer vision system of claim 22 in which, if the detected object is within a pre-defined area or distance, the system triggers further events.

27. The computer vision system of claim 26 in which the predefined area or distance is set by inputting that data directly.

28. The computer vision system of claim 22 which forms part of a voice command control device.

29. The computer vision system of claim 28 in which the functionality of the voice command control device is enhanced by being programmed to perform various functions only if a detected object is located within a pre-defined area or distance.

30. The computer vision system of claim 22 which is enhanced by being programmed to perform various functions only if a detected human is looking at the device or towards the device by detecting the pose of the body, or the orientation of the head.
